(19) United States
(12) Patent Application Publication
(10) Pub. No.: US 2025/0385367 A1
(43) Pub. Date: Dec. 18, 2025

(54) MOUNTING RACK FOR BATTERY PACK, AND VEHICLE

(71) Applicant: Anhui DeepWay Technology Co., Ltd., Hefei (CN)

(72) Inventors: Junlong FAN, Hefei (CN); Jianpeng WANG, Hefei (CN)

(21) Appl. No.: 18/900,975

(22) Filed: Sep. 30, 2024

(30) Foreign Application Priority Data
Jun. 12, 2024 (CN) 202410757973.3

(51) Int. Cl. H01M 50/249; H01M 50/242; H01M 50/262

(52) U.S. Cl. CPC H01M 50/249; H01M 50/242; H01M 50/262; H01M 2220/20

(57) ABSTRACT

Provided are a mounting rack for a battery pack, and a vehicle. The mounting rack includes a first assembly unit and a second assembly unit. The first assembly unit is disposed between two chassis beams and includes first transverse beams, first longitudinal beams, and first assembly members. Two adjacent first transverse beams and the two chassis beams located therebetween define a first accommodation cavity. The second assembly unit is disposed at a side of each chassis beam away from the first assembly unit and includes second transverse beams, second longitudinal beams, outer side beams, and second assembly members. Two second transverse beams, the chassis beam located therebetween, and the outer side beams define a second accommodation cavity. The first and second assembly members are both configured to connect the battery pack. The chassis beam is provided with at least one of the first longitudinal beam and the second longitudinal beam.

### CROSS-REFERENCE TO RELATED APPLICATIONS

This application claims the priority of the Chinese Patent Application No. 202410757973.3, filed with on June 12, 2024, which is incorporated herein by reference in its entirety.

### FIELD

The present disclosure relates to the field of new energy vehicle technologies, and more particularly, to a mounting rack for a battery pack, and a vehicle.

### BACKGROUND

At present, some new-energy heavy truck commercial vehicles on the market adopt a bottom-mounted battery pack assembly structure to cope with huge power demand and a harsh working environment. Such a structure reduces a risk of battery pack failure by combining a plurality of standard boxes or small battery casings, but it also brings a series of problems.

First of all, mounting the plurality of battery casings undoubtedly increases assembly man-hours, leading to a complex and time-consuming production process. Second, weight reduction becomes particularly difficult due to decentralized nature of the assembly structure, which not only affects energy efficiency of the vehicle, but may also lead to overall performance degradation. In addition, high and low voltage connections of the plurality of battery casings become extremely complicated, which not only be more difficult to maintain, but also leads to an increase in cost.

In terms of frame, the bottom-mounted battery pack assembly structure also brings a lot of inconvenience. The complex production process affects production efficiency, and a cost of replacement increases significantly due to the particularity of the assembly structure. More importantly, additional supports are required to support the battery casings, which increases a weight of the vehicle and in turn leads to increased energy consumption.

Therefore, it is urgent to further improve the battery pack assembly structure of the new-energy heavy truck commercial vehicle.

### SUMMARY

In the first aspect, the present disclosure provides a mounting rack for a battery pack. The mounting rack is configured to be mounted at chassis beams of a vehicle. The mounting rack has a first direction consistent with an extending direction of the chassis beam and a second direction perpendicular to the first direction. The mounting rack includes a first assembly unit and a second assembly unit. The first assembly unit is adapted to be mounted between two chassis beams. The first assembly unit includes: at least two first transverse beams arranged at intervals in the first direction, two ends of each of the at least two first transverse beams being adapted to be connected to the two chassis beams, respectively; at least two first longitudinal beams, each of the at least two first longitudinal beams being arranged between every two adjacent first transverse beams of the at least two first transverse beams, the every two adjacent first transverse beams and the two chassis beams located between the every two adjacent first transverse beams defining a first accommodation cavity configured to mount a fixing block of the battery pack, and the at least two first longitudinal beams being arranged in the first accommodation cavity and connected to the two chassis beams, respectively; and a first assembly member connected to the battery pack. The second assembly unit is adapted to be mounted at a side of each of the two chassis beams facing away from the first assembly unit. The second assembly unit includes: at least two second transverse beams arranged at intervals in the first direction, each of the at least two second transverse beams having an end adapted to be connected to the chassis beam; an outer side beam connected to an end of each of the at least two second transverse beams facing away from the chassis beam, every two adjacent second transverse beams of the at least two second transverse beams, the chassis beam located between the every two adjacent second transverse beams and the outer side beam defining a second accommodation cavity configured to mount the fixing block of the battery pack; and a second longitudinal beam arranged between the every two adjacent second transverse beams, the second longitudinal beam being connected to the chassis beam and located in the second accommodation cavity; and a second assembly member connected to the battery pack. Each of the two chassis beams is provided with at least one of the first longitudinal beam and the second longitudinal beam.

In the second aspect, the present disclosure provides a vehicle. The vehicle includes a vehicle body, two chassis beams connected to a bottom of the vehicle body, and a mounting rack for a battery pack. The mounting rack is mounted at the two chassis beams. The mounting rack has a first direction consistent with an extending direction of the chassis beam and a second direction perpendicular to the first direction. The mounting rack includes a first assembly unit and a second assembly unit. The first assembly unit is adapted to be mounted between two chassis beams. The first assembly unit includes: at least two first transverse beams arranged at intervals in the first direction, two ends of each of the at least two first transverse beams being adapted to be connected to the two chassis beams, respectively; at least two first longitudinal beams, each of the at least two first longitudinal beams being arranged between every two adjacent first transverse beams of the at least two first transverse beams, the every two adjacent first transverse beams and the two chassis beams located between the every two adjacent first transverse beams defining a first accommodation cavity configured to mount a fixing block of the battery pack, and the at least two first longitudinal beams being arranged in the first accommodation cavity and connected to the two chassis beams, respectively; and a first assembly member connected to the battery pack. The second assembly unit is adapted to be mounted at a side of each of the two chassis beams facing away from the first assembly unit. The second assembly unit includes: at least two second transverse beams arranged at intervals in the first direction, each of the at least two second transverse beams having an end adapted to be connected to the chassis beam; an outer side beam connected to an end of each of the at least two second transverse beams facing away from the chassis beam, every two adjacent second transverse beams of the at least two second transverse beams, the chassis beam located between the every two adjacent second transverse beams and the outer side beam defining a second accommodation cavity configured to mount the fixing block of the battery pack; and a second longitudinal beam arranged between the every two adjacent second transverse beams, the second longitudinal beam being connected to the chassis beam and located in the second accommodation cavity; and a second assembly member connected to the battery pack. Each of the two chassis beams is provided with at least one of the first longitudinal beam and the second longitudinal beam.

### BRIEF DESCRIPTION OF THE DRAWINGS

The above and/or additional aspects and advantages of the present disclosure will become more apparent and more understandable from the following description of embodiments taken in connection with the accompanying drawings.

FIG. 1 is a perspective view of a mounting rack according to some embodiments of the present disclosure.

FIG. 2 is a bottom view of a mounting rack according to some embodiments of the present disclosure.

FIG. 3 is a bottom view of a mounting rack according to other embodiments of the present disclosure.

FIG. 4 is another perspective view of a mounting rack according to some embodiments of the present disclosure.

FIG. 5 is an enlarged schematic view of a part in FIG. 1.

FIG. 6 is a schematic view of a connection between a first transverse beam and a chassis beam according to some embodiments of the present disclosure.

FIG. 7 is a structural view of a floating nut according to some embodiments of the present disclosure.

FIG. 8 is a schematic view of a connection between a second transverse beam and a floating nut according to some embodiments of the present disclosure.

Reference numerals in the accompanying drawings: mounting rack 100; first assembly unit 10; first transverse beam 11; first flange 111; first longitudinal beam 12; first accommodation cavity 13; first assembly member 14; positioning portion 15; positioning column 151; limit hole 152; second assembly unit 20; second accommodation cavity 2; second transverse beam 21; second flange 211; second longitudinal beam 22; second assembly member 23; outer side beam 24 reinforcing plate 25; reinforcing angle plate 26; reinforcing transverse beam 27; connector 28; first fastener 30; second fastener 40; adapter plate 50; floating nut 60; adjustable space 6; nut box 61; welding nut 62; floating square nut 63; chassis beam 200.

### DETAILED DESCRIPTION

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only and intended to explain, rather than limiting, the present disclosure.

In the description of the present disclosure, it should be understood that the orientation or position relationship indicated by the terms such as “center”, “upper”, “lower”, “vertical”, “horizontal”, “top”, “bottom”, “inner”, and “outer”, should be construed to refer to the orientations or the positions as illustrated in the drawings, and is only for the convenience of describing the present disclosure and simplifying the description, rather than indicating or implying that the referred apparatus or element must have a specific orientation, or be constructed and operated in a specific orientation. Therefore, these terms cannot be understood as limitations of the present disclosure. In addition, the features defined with “first” and “second” may explicitly or implicitly include one or more of the features. In the description of the present disclosure, “plurality” means at least two, unless otherwise specifically defined.

In the description of the present disclosure, it should be noted that terms such as “mount”, “connect”, and “couple” should be understood in a broad sense, unless otherwise clearly specified and limited. For example, they may refer to a fixed connection or a detachable connection or connection as one piece; mechanical connection or electrical connection; direct connection or indirect connection through an intermediate; or internal communication of two components. For those of ordinary skill in the art, the specific meaning of the above-mentioned terms in the present disclosure can be understood according to specific circumstances.

At present, a new-energy heavy truck commercial vehicle mainly includes two types of configurations of a battery pack, i.e., back-mounted and bottom-mounted. The back-mounted configuration refers to that the battery pack is disposed at a rear of a cab. The bottom-mounted configuration refers to that the battery pack is disposed at a bottom of a frame and connected via a mounting rack. The present disclosure provides a mounting rack for a battery pack, mainly for improving the mounting rack for a vehicle with the bottom-mounted configuration.

The present disclosure aims at solving at least one of the technical problems existing in the related art. To this end, one aspect of the present disclosure provides a mounting rack for a battery pack. The mounting rack is excellent in various aspects such as improving use strength and prolonging a service life, while having a weight reduction effect and reducing mounting difficulty of the battery pack.

Another aspect of the present disclosure further provides a vehicle.

According to embodiments in the first aspect of the present disclosure, the mounting rack for the battery pack has a first direction consistent with an extending direction of the chassis beam and a second direction perpendicular to the first direction. The mounting rack includes a first assembly unit and a second assembly unit. The first assembly unit is adapted to be mounted between two chassis beams. The first assembly unit includes: at least two first transverse beams arranged at intervals in the first direction, two ends of each of the at least two first transverse beams being adapted to be connected to the two chassis beams, respectively; at least two first longitudinal beams, each of the at least two first longitudinal beams being arranged between every two adjacent first transverse beams of the at least two first transverse beams, the every two adjacent first transverse beams and the two chassis beams located between the every two adjacent first transverse beams defining a first accommodation cavity configured to mount a fixing block of the battery pack, and the at least two first longitudinal beams being arranged in the first accommodation cavity and connected to the two chassis beams, respectively; and a first assembly member connected to the battery pack. The second assembly unit is adapted to be mounted at a side of each of the two chassis beams facing away from the first assembly unit. The second assembly unit includes: at least two second transverse beams arranged at intervals in the first direction, each of the at least two second transverse beams having an end adapted to be connected to the chassis beam; an outer side beam connected to an end of each of the at least two second transverse beams facing away from the chassis beam, every two adjacent second transverse beams of the at least two second transverse beams, the chassis beam located between the every two adjacent second transverse beams and the outer side beam defining a second accommodation cavity configured to mount the fixing block of the battery pack; and a second longitudinal beam arranged between the every two adjacent second transverse beams, the second longitudinal beam being connected to the chassis beam and located in the second accommodation cavity; and a second assembly member connected to the battery pack. Each of the two chassis beams is provided with at least one of the first longitudinal beam and the second longitudinal beam .

In the mounting rack for the battery pack according to the embodiments in the first aspect of the present disclosure, the first accommodation cavity configured to mount the fixing block of the battery pack is defined by the first assembly unit, and the battery pack is tightly connected to the mounting rack by the first assembly member. A second accommodation cavity configured to mount the fixing block of the battery pack is defined by the second assembly unit, and the battery pack is tightly connected to the mounting rack by the second assembly member. By arranging the two second accommodation cavities symmetrically relative to the first accommodation cavity, two sides of the battery pack can be subjected to bilaterally symmetrical tensile forces in the mounting rack. The symmetrical distribution of tensile forces can improve the stability of the battery pack in the mounting rack, thereby reducing a potential risk caused by uneven force and prolonging the service life of the battery pack.

By arranging the first transverse beam, connection strength between the two chassis beams is intensified, and part of stress generated in an operating process of the vehicle is effectively dispersed. In this way, overall stability of the chassis can be improved, and the vehicle can maintain a stable driving state under various road conditions. By arranging the first longitudinal beam, torsional resistance of the chassis beam is significantly enhanced. The first longitudinal beam, as a longitudinal stiffener, effectively increases resistance of the chassis beam to torsional loads. In response to complex road conditions and unexpected situations, the chassis can maintain better structural integrity and stability, thereby ensuring safety and reliability of the vehicle.

The second assembly unit includes the second transverse beams, the second longitudinal beams, and the outer side beams, which provide symmetrical and stable connection points for the battery pack at two sides. Thus, a connection effect of the battery pack to the vehicle chassis is significantly improved.

According to the mounting rack of some embodiments of the present disclosure, a first flange is formed at each of two ends of the first transverse beam; a second flange is formed at an end of the second transverse beam; corresponding to each of the two chassis beams, the first flange and the second flange are connected to each other through a plurality of first fasteners penetrating the chassis beam; at least one of the first transverse beam and the second transverse beam penetrates the chassis beam through a plurality of second fasteners; and the first flange overlaps an end of the first longitudinal beam and is fixed on the chassis beam through a third fastener penetrating the first flange, and/or the second flange overlaps an end of the second longitudinal beam and is fixed on the chassis beam through a fourth fastener penetrating the second flange.

According to the mounting rack of some embodiments of the present disclosure, the first assembly member is disposed at the first transverse beam, and the second assembly member is disposed at the first longitudinal beam and the outer side beam; or the first assembly member is disposed at the first longitudinal beam, and the second assembly member is disposed at the second transverse beam.

According to the mounting rack of some embodiments of the present disclosure, each of the first assembly member and the second assembly member is a floating nut.

According to the mounting rack of some embodiments of the present disclosure, the first assembly unit includes three first transverse beams to define two first accommodation cavities. Two lateral first transverse beams of the three first transverse beams are each provided with a positioning portion configured to position the battery pack.

In some embodiments, two positioning portions are symmetrically arranged relative to a middle first transverse beam of the three first transverse beams.

In some embodiments, the positioning portion includes a square positioning column; a circular limit hole is formed at a center of the square positioning column; and the positioning portion is integrally formed at the first transverse beam.

In some embodiments, the two chassis beams are correspondingly provided with two second assembly units, respectively; each of the two second assembly units comprises three second transverse beams to define two second accommodation cavities; and the outer side beam is connected to ends of the three second transverse beams facing away from the corresponding chassis beam.

In some optional embodiments, on each second assembly unit, at least two outer side beams are arranged at intervals in a vertical direction; two outer side beams of the at least two outer side beams are connected through a reinforcing plate; and each of the at least two outer side beams is connected to the second transverse beam, a reinforcing angle plate being connected between the outer side beam and the second transverse beam.

According to the mounting rack of some embodiments of the present disclosure, the first transverse beam, the first longitudinal beam, the second transverse beam, and the second longitudinal beam are each a cast part.

According to the vehicle of the embodiments in the second aspect of the present disclosure, the vehicle includes a vehicle body, two chassis beams connected to a bottom of the vehicle body, and a mounting rack mounted at the two chassis beams. The mounting rack for the battery pack is the mounting rack for the battery pack according to the embodiments in the first aspect of the present disclosure.

In the vehicle according to some embodiments of the present disclosure, a stable and reliable energy support structure for the vehicle is provided by the mounting rack for the battery pack.

Additional aspects and advantages of the embodiments of the present disclosure will be given at least in part in the following description, or become apparent at least in part from the following description, or can be learned from practicing of the embodiments of the present disclosure.

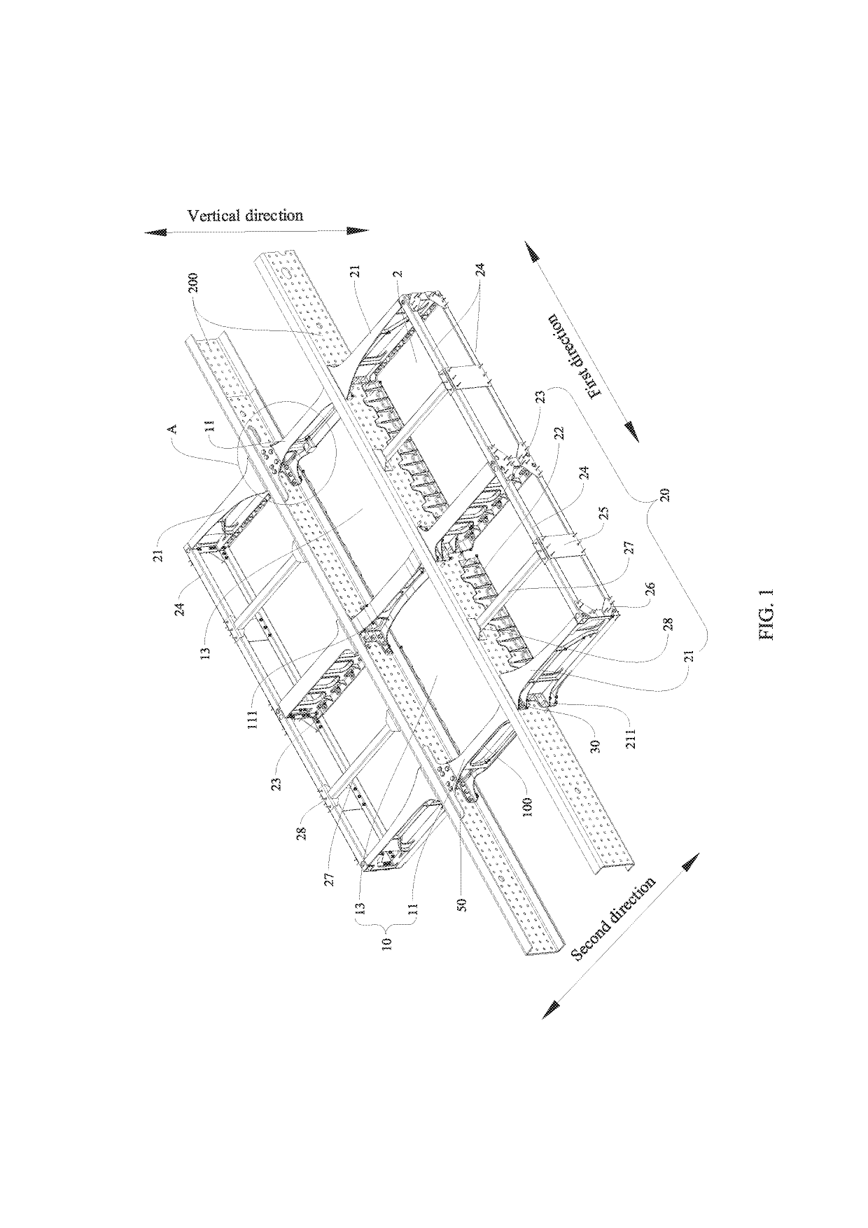

A mounting rack 100 for a battery pack according to the embodiments of the present disclosure is described below with reference to FIG. 1 to FIG. 8. The mounting rack 100 is mounted at chassis beams 200 of the vehicle and is configured to connect to the battery pack.

According to some embodiments in a first aspect of the present disclosure, the mounting rack 100 for the battery pack has a first direction and a second direction. As illustrated in FIG. 1, the first direction is an extending direction of the chassis beam 200, and the second direction is perpendicular to the first direction.

As illustrated in FIG. 1 to FIG. 3, the mounting rack 100 for the battery pack includes a first assembly unit 10 and second assembly units 20. The first assembly unit 10 and the second assembly unit 20 are both configured to connect to the battery pack.

The first assembly unit 10 is adapted to be mounted between two chassis beams 200 of the vehicle. On the one hand, the first assembly unit 10 is configured to connect to a fixing block of the battery pack, and on the other hand, the first assembly unit 10 can enhance connection stability between two chassis beams 200.

Two second assembly units 20 are provided. The two second assembly units 20 are arranged and spaced apart from each other in the second direction. Each second assembly unit 20 is mounted at a side, facing away from the first assembly unit 10, of a corresponding chassis beam 200. As illustrated in FIG. 1, the two second assembly units 20 are arranged symmetrically relative to the first assembly unit 10, for the symmetry in an overall structure.

The second assembly unit 20 is connected to the fixing block of the battery pack, for ensuring the stable and symmetrical connection of the battery pack on the vehicle. The battery pack can maintain a balance between the left and the right, no matter when the vehicle is driving in a straight line or turning, without causing drifting or shaking.

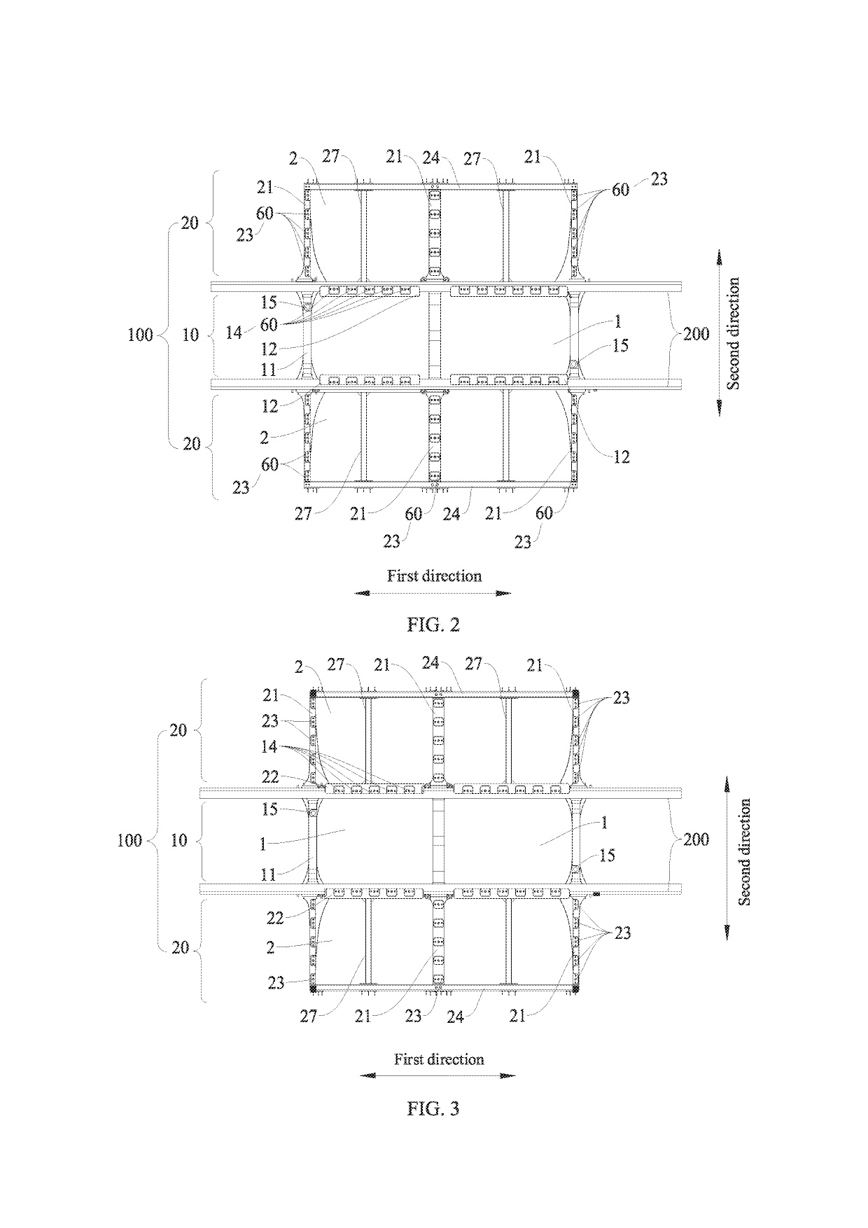

As illustrated in FIG. 2, the first assembly unit 10 includes first transverse beams 11 and first longitudinal beams 12.

Two ends of the first transverse beam 11 are adapted to be connected to the two chassis beams 200, respectively. At least two first transverse beams 11 are provided and arranged at intervals in the first direction. The first transverse beams 11 are not only effectively connect the two chassis beams 200, but also balance weights of the second assembly units 20 at two sides.

Since the second assembly units 20 are located at two sides, a balance of a chassis may be affected by the weight borne by the second assembly units 20. The first transverse beam 11 can balance the weight borne by the second assembly units 20. By connecting the two chassis beams 200, the first transverse beam 11 forms a powerful supporting structure to ensure that the weight borne by the second assembly units 20 can be evenly distributed to the two chassis beams 200, thereby effectively avoiding uneven weight distribution at two ends of the vehicle. In this way, the mounting rack 100 can be prevented from being partially damaged due to an excessive force applied to one end. Therefore, the stability and safety of the vehicle during driving can be ensured.

The first longitudinal beam 12 is disposed between every two adjacent first transverse beams 11. The first longitudinal beam 12 can reinforce strength of the chassis beam 200 and disperse the force applied to the chassis beam 200 in a driving process of the vehicle, thereby reducing a load burden of the chassis beam 200. The first longitudinal beam 12 can reduce a risk of twisting the chassis beams 200, which may be subjected to a great twisting force under a complex road condition, especially in cases of turning, bumping, or emergency braking.

Every two adjacent first transverse beams 11 and the two chassis beams 200 located between every two adjacent first transverse beams 11 define a first accommodation cavity 13 configured to mount the fixing block of the battery pack.

It is worth noting that a plurality of protruding fixing blocks may be formed on the battery pack as a whole. The fixing blocks in a middle part of the battery pack are located in the first accommodation cavity 13.

At least two first longitudinal beams 12 are provided and located in the first accommodation cavity 13. The two first longitudinal beams 12 are connected to the two chassis beams 200, respectively. The first longitudinal beams 12 can distribute the force from the chassis beams 200.

In some embodiments, the first transverse beam 11 extends vertically, that is, the first transverse beam 11 has a certain height, and the first transverse beam 11 has a plurality of lightening holes arranged at non-main force-bearing points of the first transverse beam 11. In this way, it can be ensured that the first transverse beam 11 has the maximal support effect on the chassis, while a weight of the mounting rack 100 is reduced, which is beneficial to vehicle lightweighting.

As illustrated in FIG. 1, the first assembly unit 10 is provided with a first assembly member 14 connected to the battery pack. The fixing block of the battery pack is connected to the mounting rack 100 through the first assembly member 14.

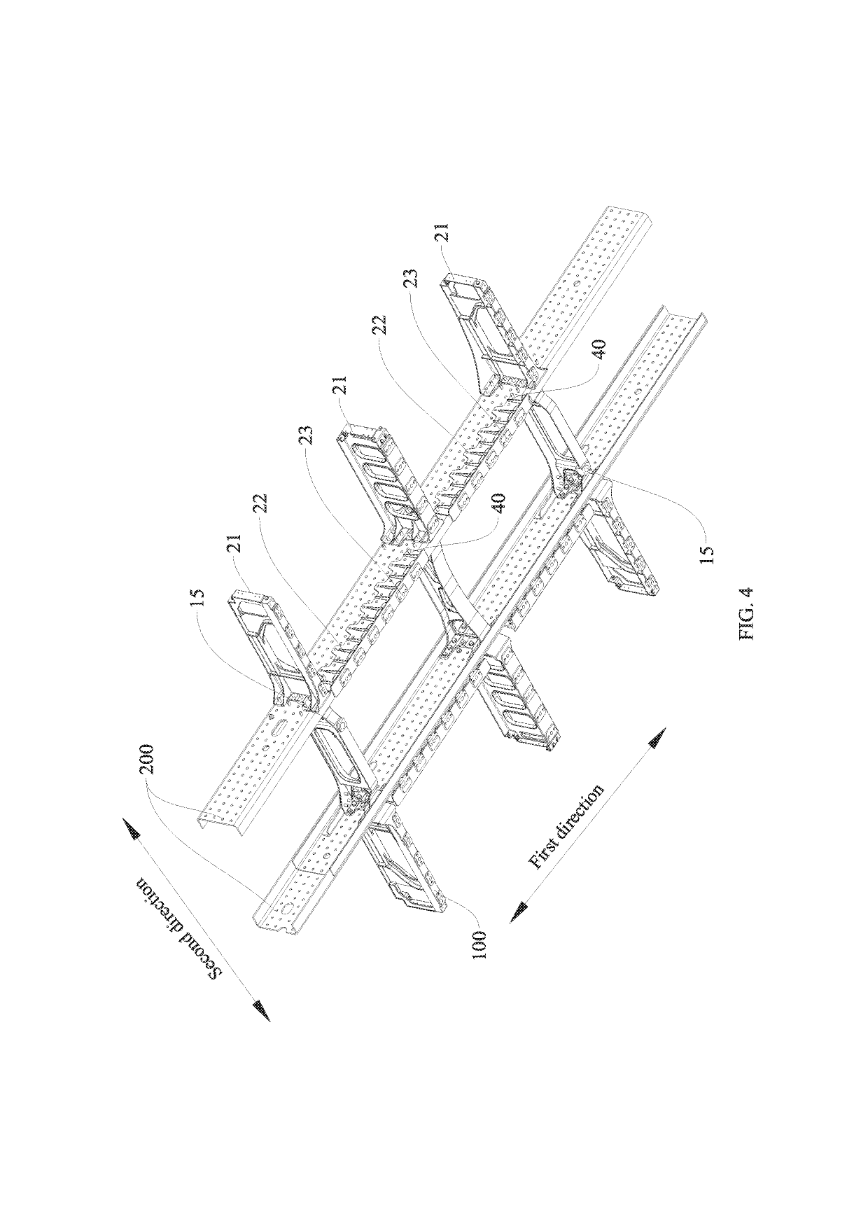

As illustrated in FIG. 1, FIG. 3, and FIG. 4, the second assembly unit 20 includes second transverse beams 21, second longitudinal beams 22, and outer side beams 24.

An end of the second transverse beam 21 is adapted to be connected to the chassis beam 200. At least two second transverse beams 21 are provided and arranged at intervals in the first direction.

A plurality of second transverse beams 21 form a frame structure, which can enhance supporting strength of the mounting rack 100, and can also resist impact and vibration from different directions, thereby improving the safety of the battery pack.

In addition, by providing the plurality of second transverse beams 21, a risk of damage to the overall structure caused by damage of a single second transverse beam 21 is avoided. In actual use, even if one of the second transverse beams 21 is damaged due to various reasons, the other second transverse beams 21 can still maintain structural integrity, thereby ensuring a normal operation of the vehicle.

Additionally, the plurality of second transverse beams 21 allows the maintenance and replacement to be convenient for an operator. The operator can replace one of the second transverse beams 21 as required without disassembling the whole mounting rack 100.

In some embodiments, the second transverse beam 21 extends vertically, that is, the second transverse beam 21 has a certain height. The second transverse beam 21 has a plurality of lightening holes. The plurality of lightening holes is formed at non-main force-bearing points of the second transverse beam 21. In this way, it is ensured that the second transverse beam 21 has a supporting effect on the chassis beam 200, while the overall weight of the mounting rack 100 is reduced, which contributes to the vehicle lightweighting.

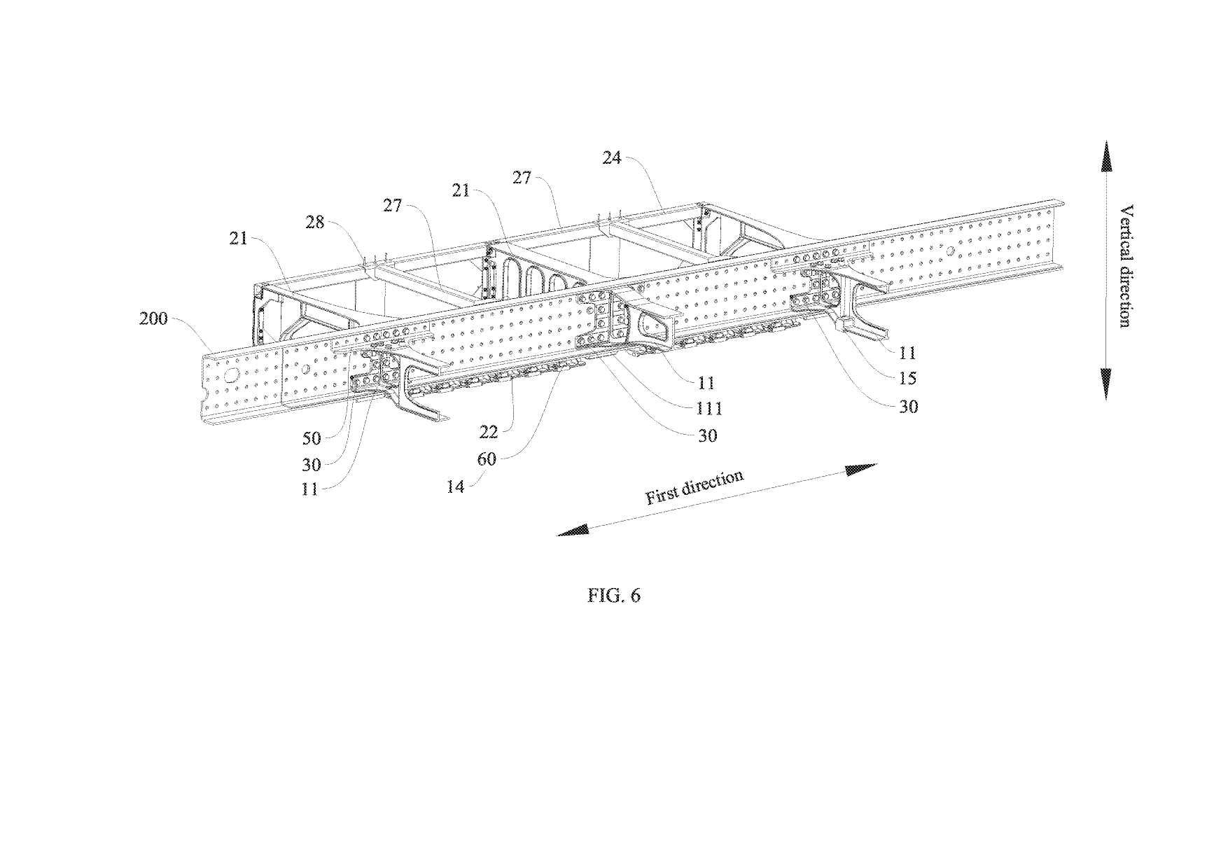

As illustrated in FIG. 1, FIG. 3, and FIG. 6, the outer side beam 24 is connected to an end of the second transverse beam 21 facing away from the chassis beam 200. Every two adjacent second transverse beams 21, the chassis beam 200 located between every two adjacent second transverse beams 21, and the outer side beam 24 define a second accommodation cavity 2 configured to mount the fixing block of the battery pack.

The fixing blocks located at two sides of the battery pack are adapted to mounted in the second accommodation cavity 2, such that the fixing blocks of the battery pack and the second assembly unit 20 are tightly connected, which effectively prevents the battery pack from shaking or shifting during the driving of the vehicle. Therefore, the reliability of the battery pack and the safety of the overall structure can be enhanced.

As illustrated in FIG. 3 and FIG. 4, one second longitudinal beam 22 is disposed between every two adjacent second transverse beams 21. The second longitudinal beam 22 is connected to the chassis beam 200 and located in the second accommodation cavity 2. The second longitudinal beam 22 has a structural reinforcement effect on the chassis beam 200 as well as a force-distributing effect on the chassis beam 200.

The second assembly unit 20 is provided with a second assembly member 23 for connecting to the battery pack. The second assembly member 23 is configured to connect the battery pack to the mounting rack 100.

At least one of the first longitudinal beam 12 and the second longitudinal beam 22 is disposed at the chassis beam 200.

In an example, as illustrated in FIG. 2, when the first longitudinal beams 12 are provided on the chassis beam 200, the first accommodation cavity 13 is defined by every two adjacent first transverse beams 11 and the two first longitudinal beams 12 located between every two adjacent first transverse beams 11.

In another example, as illustrated in FIG. 3, when the second longitudinal beam 22 is provided on the chassis beam 200, the second accommodation cavity 2 is defined by every two adjacent second transverse beams 21, the second longitudinal beam 22 located between every two adjacent second transverse beams 21, and the outer side beam 24.

In yet another example, when the first longitudinal beam 12 and the second longitudinal beam 22 are provided on the chassis beam 200 at the same time, the first accommodation cavity 13 and the second accommodation cavity 2 are respectively defined by the structures described in the above two examples, which are not repeated herein.

It is worth noting that the mounting rack 100 forms a frame structure by connecting various beams, reducing a material coverage of an entire surface, and by forming lightening holes, the amount of material consumption can be reduced, while maintaining the structural strength and stiffness. Thus, the overall weight of the mounting rack 100 can be reduced, which contributes to the vehicle lightweighting.

The mounting rack 100 is connected to the battery pack through the first assembly unit 10 and the second assembly unit 20, while meeting the heat dissipation requirements of the battery pack and allowing the heat generated by the battery pack to be rapidly transmitted outside through gaps between the beams, thereby contributing to a heat dissipation function.

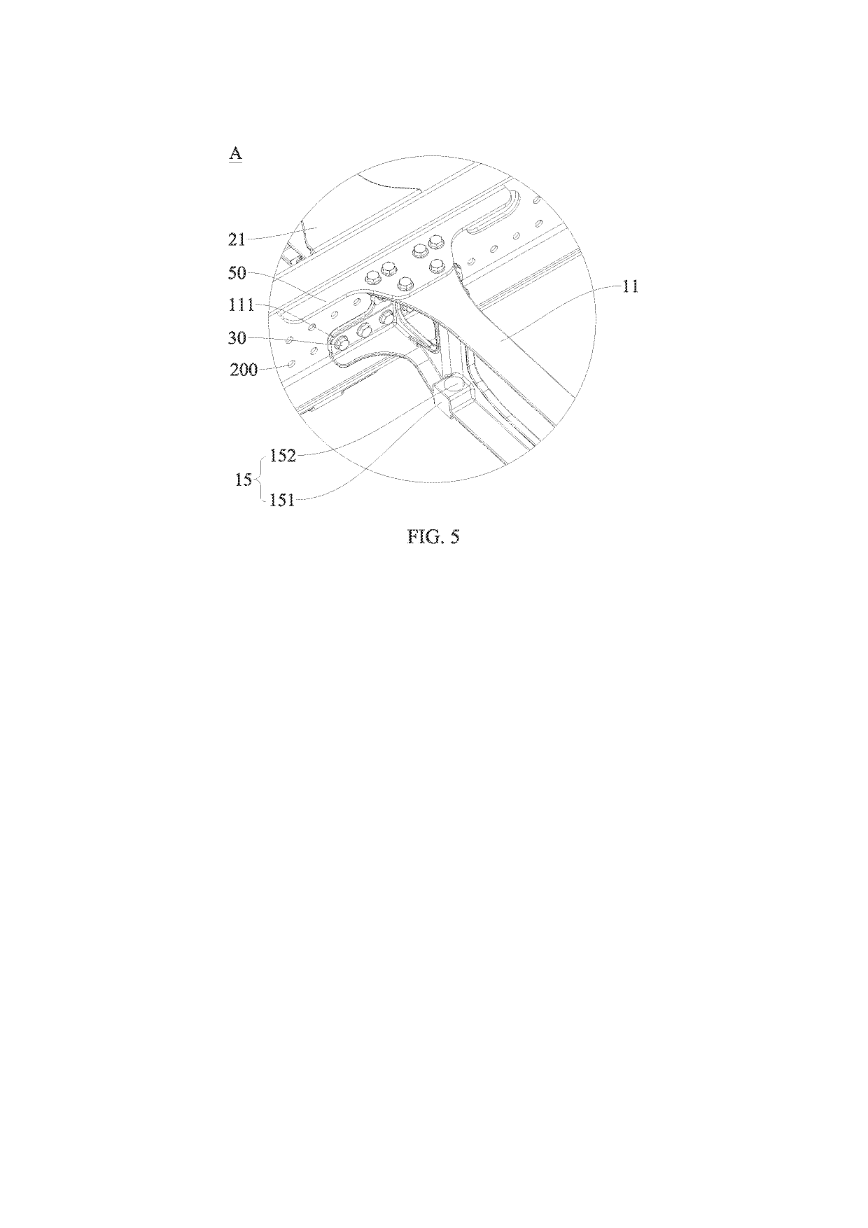

As illustrated in FIG. 1 and FIG. 5, for the mounting rack 100 for the battery pack according to some embodiments of the present disclosure, a first flange 111 is formed at each of two ends of the first transverse beam 11, respectively, and a second flange 211 is formed at one end of the second transverse beam 21. Corresponding to each chassis beam 200, the first flange 111 and the second flange 211 are connected to each other through a plurality of first fasteners 30 penetrating the chassis beam 200.

The chassis beam 200 has a through hole. The first fastener 30 passes through the through hole and is connected to the first flange 111 and the second flange 211 located at two ends of the through hole.

The first flange 111 and the second flange 211 intensify the structural strength of connection positions of the first transverse beam 11, the second transverse beam 21, and the chassis beam 200, while reducing a number of members.

In the embodiment illustrated in FIG. 4 and FIG. 6, an end surface of the first flange 111 extends outward to form a I-shaped structure.

Upper and lower transverse beams of the I-shaped structure are connected to a middle longitudinal beam of the I-shaped structure to form a stable support frame. The support frame can disperse and resist to external force under stress, thereby improving the stability of the whole structure.

In addition, a connection end surface of the I-shaped structure has a relatively large contact area, which can be better connected to other members and increase stability of the connection. The relatively large contact area means that more force can be dispersed at the connection, reducing stress at the connection and thus reducing a damage risk due to stress concentration.

In addition, the I-shaped structure further has good torsional resistance, which can prevent deformation or fracture under torsional force and maintain good stability. In this case, the I-shaped structure enhances the torsional resistance of the chassis beam 200 and reduces the possibility of deformation and damage of the chassis beam 200.

In another embodiment of the present disclosure, the first fastener 30 includes a bolt, nut, or the like.

At least one of the first longitudinal beam 12 and the second longitudinal beam 22 penetrates the chassis beam 200 through a plurality of second fasteners 40. In an example, when only the first longitudinal beam 12 is provided, the first longitudinal beam 12 is connected to the chassis beam 200 through the second fasteners 40. In another example, as illustrated in FIG. 4, when only the second longitudinal beam 22 is provided, the second longitudinal beam 22 is connected to the chassis beam 200 through the second fasteners 40. In yet another example, when both the first longitudinal beam 12 and the second longitudinal beam 22 are provided, the first longitudinal beam 12 and the second longitudinal beam 22 are connected to the chassis beam 200 through the second fasteners 40.

In some embodiments not illustrated in the figures, the first flange 111 overlaps an end of the first longitudinal beam 12 and is fixed on the chassis beam 200 through a third fastener penetrating the first flange 111. Such overlapping arrangement enables the first longitudinal beam 12 and the first transverse beam 11 to form a whole at the connection, thereby enhancing the integrity and stability of the mounting rack 100. In this case, the third fastener ensures the tightness and reliability of the connection to allow the battery pack to remain stable in the driving process of the vehicle.

Additionally or alternatively, the second flange 211 overlaps an end of the second longitudinal beam 22 and is fixed on the chassis beam 200 through a fourth fastener penetrating the second flange 211. The second flange 211 and the end of second longitudinal beam 22 are also arranged to overlap and are fixed on the chassis beam 200 through the fourth fastener, which ensures the structural integrity of the battery pack and the reliability of the connection.

In an embodiment of the present disclosure, as illustrated in FIG. 1, an end surface of the second flange 211 connected to the second longitudinal beam 22 is bent and extends outward to form an extension surface. Therefore, the connection between the second transverse beam 21 and the second longitudinal beam 22 forms an overlapping effect. Thus, a connection area is increased to allow the connection to be more reliable and to effectively disperse the stress concentration at the connection.

It is worth noting that, through the third fastener and the fourth fastener, a closed-loop connection effect is formed at connections between the first transverse beam 11 and the first longitudinal beam 12 and between the second transverse beam 21 and the second longitudinal beam 22. This closed-loop connection enables the mounting rack 100 for the entire battery pack to be more stable and reliable. In the assembly process, since the transverse beam and longitudinal beam are not welded or integrally formed, the connection has a certain pressure-tolerant capacity, which helps to reduce stress concentration and reduce assembly difficulty.

In some embodiments, an adapter plate 50 is further disposed at the connection between the first transverse beam 11 and the chassis beam 200. The adapter plate 50 is formed in an L shape. One surface of the adapter plate 50 is connected to the first transverse beam 11, and another surface of the adapter plate 50 is connected to the chassis beam 200. The adapter plate 50 serves as an intermediate member between the first transverse beam 11 and the chassis beam 200, for increasing the connection area. Such an arrangement can not only better disperse stress and reduce stress concentration, but also improve the stability of the connection.

In addition, due to good stability and torsional resistance of the L-shaped structure, a force between the first transverse beam 11 and the chassis beam 200 can be effectively transmitted and dispersed. In another embodiment of the present disclosure, connection between the adapter plate 50 and the first transverse beam 11 and the chassis beam 200 can be realized through welding, bolt connection, or the like.

In another embodiment of the present disclosure, as illustrated in FIG. 5, the adapter plate 50 is disposed at a connection between each of two lateral first transverse beams 11 and the chassis beam 200.

According to some embodiments not illustrated in the figures, the first assembly member 14 is disposed at the first transverse beam 11, and the second assembly member 23 is disposed at the first longitudinal beam 12 and the outer side beam 24.

The first assembly member 14 is provided to support the weight of the battery pack together with the first transverse beam 11, to ensure a stable mounting of the battery pack on the chassis beam 200, and to absorb vibration and impact generated by the battery pack of the vehicle during driving.

The second assembly member 23 is disposed at the first longitudinal beam 12 and the outer side beam 24, to cooperate with the first assembly member 14. The first longitudinal beam 12, as a main support structure in the battery pack, is connected to the first assembly member 14 through the second assembly member 23, thereby guaranteeing the stability of the battery pack in the first direction.

The outer side beam 24 serves as a peripheral protection structure of the battery pack. The second assembly member 23 on the outer side beam 24 not only intensify the overall strength of the battery pack, but also helps to prevent an interior of the battery pack from being damaged by external impact.

In another embodiment of the present disclosure, as illustrated in FIG. 2, the first assembly member 14 is disposed at the first longitudinal beam 12, and the second assembly member 23 is disposed at the second transverse beam 21.

In yet another embodiment of the present disclosure, as illustrated in FIG. 3 and FIG. 8, the first assembly member 14 is disposed at the second longitudinal beam 22, and the second assembly member 23 is disposed at the second transverse beam 21.

The first longitudinal beam 12 or the chassis beam 200 is connected to the battery pack through the first assembly member 14.

The second assembly member 23 is configured to connect the two sides of the battery pack to the plurality of second transverse beams 21, and distribute the weight, thereby preventing the second transverse beam 21 at a single position from bearing excessive pressure. Therefore, the service life of the mounting rack 100 can be prolonged.

A plurality of mounting points formed by the first assembly members 14 and the second assembly members 23 is double-E-shaped, as illustrated in FIG. 2 and FIG. 3. The double-E-shaped mounting points can improve a modality of the battery pack in the second direction and effectively reduce a vibration amplitude generated when the two sides of the battery pack are subjected to vibration. In this way, a risk of disconnection and desoldering of an electrical circuit on the battery pack can be avoided, thereby ensuring the reliability of the battery pack.

According to some embodiments of the mounting rack 100 for the battery pack, as illustrated in FIG. 2, the first assembly member 14 and the second assembly member 23 are each a floating nut 60. The floating nut 60 can ensure assembly stability and effectively absorb accumulated tolerance in the assembly process, preventing problems such as loose assembly or misalignment caused by the tolerance accumulation. Therefore, the requirement on the perpendicularity between the mounting rack 100 and the respective mounting points on battery pack can be satisfied.

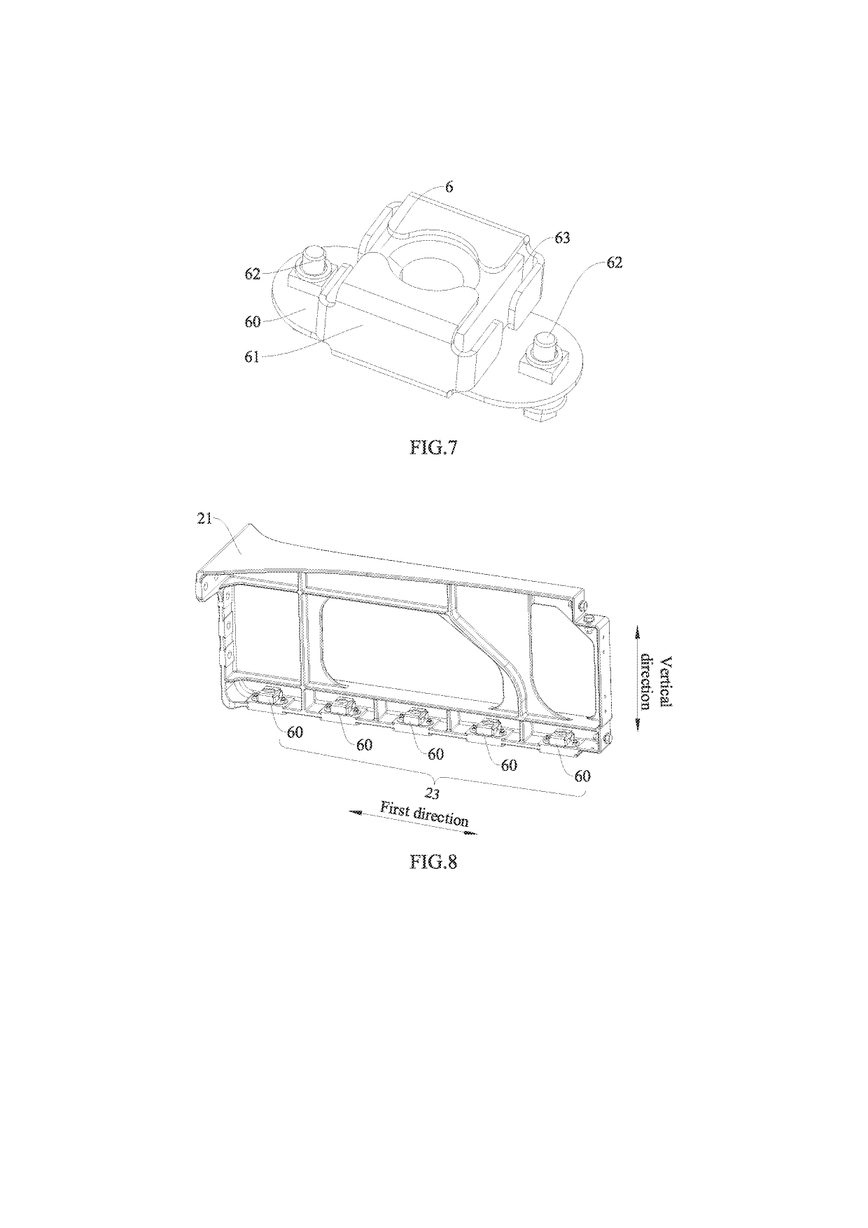

As illustrated in FIG. 7, in some embodiments, the floating nut 60 includes a nut box 61, two weld nuts 62, and a floating square nut 63. The nut box 61 has an adjustable space 6 defined therein, and the floating square nut 63 is disposed in the adjustable space 6. The floating square nut 63 can move horizontally in the adjustable space 6 and has a threaded hole. The threaded hole is not fixed, i.e., the threaded hole can be fine-tuned horizontally as needed. That is, a fine adjustment of a position of the threaded hole can be achieved by adjusting a horizontal position of the floating square nut 63 in the adjustable space 6. The fine adjustment not only enables the battery pack to be mounted in a stable and reliable manner, but also improves the efficiency of the connection between the battery pack and mounting rack 100.

According to some embodiments of the mounting rack 100 for the battery pack, as illustrated in FIG. 1 to FIG. 3, the first assembly unit 10 includes three first transverse beams 11, and thus two first accommodation cavities 13 are defined by the three first transverse beams 11. As illustrated in FIG. 2 to FIG. 4, two lateral first transverse beams 11 of the three first transverse beams 11 are each provided with a positioning portion 15 configured to position the battery pack. Two fixing blocks located at a middle of the battery pack are mounted in the two first accommodation cavities 13, respectively. The battery pack can be effectively fixed by connecting the fixing blocks of the battery pack to the mounting rack 100, thereby preventing the battery pack from shaking during operation.

The two positioning portions 15 are symmetrically arranged relative to a middle first transverse beam 11 of the three first transverse beams 11. The positioning portions 15 are configured to accurately position the battery pack, to ensure that the battery pack is in the correct position during assembly. By improving assembly accuracy, the battery pack can be prevented from shifting or tilting during the assembly, thereby ensuring the use safety of the battery pack.

In the mounting rack 100 for the battery pack according to some embodiments of the present disclosure, as illustrated in FIG. 5, the positioning portion 15 includes a square positioning column 151. A circular limit hole 152 is formed at a center of the square positioning column 151. The positioning portion 15 is integrally formed at the first transverse beam 11.

The square positioning column 151 enables a connection between the positioning portion 15 and the mounting rack 100 to be more stable.

The circular limit hole 152 can accurately match with a corresponding part on the battery pack, thereby enabling a faster and more accurate positioning process. Accordingly, steps and time of the assembly are reduced, thereby reducing the potential errors in the assembly process.

By providing the positioning portion 15 on the first transverse beam 11, the battery pack can be accurately pre-positioned in the first direction, which facilitates subsequent mounting.

As for the mounting rack 100 for the battery pack according some embodiments of the present disclosure, each chassis beam 200 is correspondingly provided with one second assembly unit 20. The second assembly unit 20 includes three second transverse beams 21 to define two second accommodation cavities 2. The outer side beam 24 is connected to an end of the three second transverse beams 21 facing away from the corresponding chassis beam 200.

Four fixing blocks at the two sides of the battery pack can be accurately placed in the second accommodation cavities 2 at two sides. In this way, the battery pack and the mounting rack 100 can be tightly connected, which increases the connectivity of the battery pack and effectively reduces the risk of battery pack deflection.

The outer side beam 24 is connected to ends of the three second transverse beams 21 facing away from the chassis beam 200 to form a complete frame, which enhances the stability and rigidity of the mounting rack 100. In addition, in cases of a vehicle collision or other accident, the frame can absorb and disperse part of the impact force, protecting the battery pack from being damaged.

In some embodiments as illustrated in FIG. 1, on each second assembly unit 20, at least two outer side beams 24 are arranged at intervals in a vertical direction. Two outer side beams 24 are connected through a reinforcing plate 25.

The reinforcing plate 25 can intensify a supporting force between the two outer side beams 24, effectively avoiding a shaking that may occur between the two outer side beams 24. In this way, the stability of the second accommodation cavity 2 can be ensured.

In some optional embodiments, the outer side beam 24 may be an L- or square-shaped outer side beam member in cross-section. For example, the vertically upper outer side beam 24 is the square-shaped outer side beam member, while the vertically lower outer side beam 24 is the “L” shaped outer side beam member.

In another embodiment of the present disclosure, the reinforcing plate 25 is a high-strength steel plate, which further improves a supporting effect on the outer side beam 24.

The outer side beam 24 is connected to the second transverse beam 21. A reinforcing angle plate 26 is connected between the outer side beam and the second transverse beam 21. The reinforcing angle plate 26 provides a reinforcing effect that enhances a bearing capacity of the entire second assembly unit 20 while improving the torsional resistance of the mounting rack 100.

In another embodiment of the present disclosure, both the reinforcing plate 25 and the reinforcing angle plate 26 are high-strength steel plates, which further increases the strength of mounting rack 100.

In the mounting rack 100 for the battery pack according to some embodiments of the present disclosure, the first transverse beam 11, the first longitudinal beam 12, the second transverse beam 21, and the second longitudinal beam 22 are each a cast part.

The cast part has high strength and rigidity due to the dense internal structure without defects such as pores and slag inclusion. In the mounting rack 100 for the battery pack, the first transverse beam 11, the first longitudinal beam 12, the second transverse beam 21, and the second longitudinal beam 22 serve as critical support and connection members that are required to withstand various forces and vibrations from the battery pack and the vehicle. When the cast parts are employed to serve as these parts, these parts can have sufficient rigidity and strength to cope with a variety of complex operating environments.

In addition, the cast part also has high production efficiency and can reduce production costs.

In the mounting rack 100 for the battery pack according to some embodiments of the present disclosure, as illustrated in FIG. 1 to FIG. 3, the second assembly unit 20 further includes a reinforcing transverse beam 27. Two ends of the reinforced transverse beam 27 are respectively connected to the outer side beam 24 and the chassis beam 200 at the same side. The reinforcing transverse beam 27 exerts a certain tensile force on the second assembly unit 20, and a vibration amplitude on two sides of the mounting rack 100 is correspondingly reduced.

In another embodiment of the present disclosure, a cross-section of the reinforcing transverse beam 27 is in a square shape. The two ends of the reinforced transverse beam 27 are connected to the outer side beam 24 and the chassis beam 200 through a connector 28.

According to the vehicle of the embodiments in the second aspect of the present disclosure, the vehicle includes a vehicle body, two chassis beams 200, and the mounting rack 100. The chassis beam 200 is connected to s bottom of the vehicle body and is disposed in a length direction of the vehicle body. The mounting rack 100 is mounted at the chassis beam 200

In the vehicle according to the embodiments of the present disclosure, by improving the stability and the reliability of the mounting rack, a safety performance of the battery pack is ensured, and by reducing the weight of the mounting rack, the production cost of the vehicle can be reduced and energy utilization is improved.

A mounting rack 100 according to a specific embodiment of the present disclosure is described below with reference to FIG. 1, and FIG. 3 to FIG. 8.

Referring to FIG. 1 and FIG. 3 to FIG. 5, the mounting rack 100 includes a first assembly unit 10, second assembly units 20, first fasteners 30, second fasteners 40, and adapter plates 50.

Referring to FIG. 3, the first assembly unit 10 is mounted between two chassis beams 200 of the vehicle.

The first assembly unit 10 includes three first transverse beams 11, first accommodation cavities 13, first assembly members 14, and positioning portions 15.

The three first transverse beams 11 are arranged at intervals in the first direction. Two ends of each first transverse beam 11 are connected to the two chassis beams 200, respectively.

Referring to FIG. 3 and FIG. 4, two positioning portions 15 are provided and respectively formed at the two lateral first transverse beams 11 of the three first transverse beams 11. The two positioning portions 15 are arranged symmetrically relative to the middle first transverse beam 11 of the three first transverse beams 11.

The positioning portion 15 includes a square positioning column 151. A circular limit hole 152 is formed at the center of the square positioning column 151.

Referring to FIG. 3, the first accommodation cavity 13 is defined by every two adjacent first transverse beams 11 and the two chassis beams 200 located between every two adjacent first transverse beams 11.

Referring to FIG. 5 and FIG. 6, first flanges 111 are formed at two ends of each first transverse beam 11.

The adapter plate 50 is disposed at two ends of the two lateral first transverse beams 11. The adapter plate 50 is of an L shape. One part of the adapter plate 50 is connected to the first transverse beam 11, and another part of the adapter plate 50 is connected to the chassis beam 200.

Referring to FIG. 3, the first assembly member 14 is a floating nut 60 and is disposed at the second longitudinal beam 22.

The second assembly unit 20 is mounted at a side of each chassis beam 200 facing away from the first assembly unit 10.

Referring to FIG. 1, the second assembly unit 20 includes three second transverse beams 21, second longitudinal beams 22, second assembly members 23, two outer side beams 24, reinforcing plates 25, reinforcing angle plates 26, reinforcing transverse beams 27, and connectors 28.

The three second transverse beams 21 are arranged at intervals in the first direction. An end of each second transverse beam 21 is connected to the chassis beam 200. The two outer side beams 24 are both connected to the ends of the second transverse beams 21 facing away from the chassis beam 200.

The two outer side beams 24 are arranged at intervals in the vertical direction.

The reinforcing plate 25 is disposed between the two outer side beams 24.

The reinforcing angle plate 26 is disposed between the outer side beam 24 and the second transverse beam 21.

The reinforced transverse beam 27 is disposed between the outer side beam 24 and the chassis beam 200 at the same side.

A second flange 211 is formed at an end of the second transverse beam 21. The first flange 111 and the second flange 211 are connected to each other through a plurality of first fasteners 30 penetrating the two chassis beam 200.

The second longitudinal beam 22 is disposed between two adjacent second transverse beams 21. The second longitudinal beam 22 is connected to the chassis beam 200 and located in the second accommodation cavity 2.

Referring to FIG. 4, the second fastener 40 is configured to connect the second longitudinal beam 22 to the chassis beam 200.

The second accommodation cavity 2 is defined by every two adjacent second transverse beams 21, the second longitudinal beam 22 located between every two adjacent second transverse beams 21 and the outer side beams 24. The second flange 211 overlaps an end of the second longitudinal beam 22 and is fixed on the chassis beam 200 through a fourth fastener penetrating the second flange 211.

The connector 28 is disposed at two ends of the reinforcing transverse beam 27.

The second assembly member 23 is a floating nut 60 and is disposed at the second transverse beam 21.

Referring to FIG. 7, the floating nut 60 includes a nut box 61, two weld nuts 62, and a floating square nut 63.The adjustable space 6 is formed in the nut box 61, and the floating square nut 63 is disposed in the adjustable space 6. Therefore, the floating square nut 63 can move horizontally in the adjustable space 6 and has the threaded hole.

Other configurations of the mounting rack according to the embodiments of the present disclosure, such as vehicles, etc., are known to those of ordinary skill in the art and will not be described in detail herein.

In the specification, description with reference to the term “embodiment” or “example”, etc., means that specific features, structure, materials or characteristics described in connection with the embodiment or example are included in at least one embodiment or example of the present disclosure. In this specification, the schematic representations of the above terms do not necessarily refer to the same embodiment or example. Moreover, the described specific features, structures, materials or characteristics may be combined in any one or more embodiments or examples in a suitable manner.

Although embodiments of the present disclosure have been illustrated and described, it should be understood by those of ordinary skill in the art that various changes, modifications, replacements, and variations can be made to these embodiments without departing from the principles and spirit of the present disclosure. The scope of the present disclosure shall be defined by the claims as appended and their equivalents.

What is claimed is:

1. A mounting rack for a battery pack, the mounting rack being configured to be mounted at chassis beams of a vehicle, the mounting rack having a first direction consistent with an extending direction of the chassis beams and a second direction perpendicular to the first direction, the mounting rack comprising:
a first assembly unit adapted to be mounted between two chassis beams, wherein the first assembly unit comprises:
at least two first transverse beams arranged at intervals in the first direction, two ends of each of the at least two first transverse beams being adapted to be connected to the two chassis beams, respectively;
at least two first longitudinal beams, each of the at least two first longitudinal beams being arranged between every two adjacent first transverse beams of the at least two first transverse beams, the every two adjacent first transverse beams and the two chassis beams located between the every two adjacent first transverse beams defining a first accommodation cavity configured to mount a fixing block of the battery pack, and the at least two first longitudinal beams being arranged in the first accommodation cavity and connected to the two chassis beams, respectively; and
a first assembly member connected to the battery pack;
a second assembly unit adapted to be mounted at a side of each of the two chassis beams facing away from the first assembly unit, the second assembly unit comprising:
at least two second transverse beams arranged at intervals in the first direction, each of the at least two second transverse beams having an end adapted to be connected to the chassis beam;
an outer side beam connected to an end of each of the at least two second transverse beams facing away from the chassis beam, wherein every two adjacent second transverse beams of the at least two second transverse beams, the chassis beam located between the every two adjacent second transverse beams, and the outer side beam define a second accommodation cavity configured to mount a fixing block of the battery pack; and
a second longitudinal beam arranged between the every two adjacent second transverse beams, the second longitudinal beam being connected to the chassis beam and located in the second accommodation cavity; and
a second assembly member connected to the battery pack,
wherein each of the two chassis beams is provided with at least one of the first longitudinal beam and the second longitudinal beam.

2. The mounting rack according to claim 1, wherein:
a first flange is formed at each of the two ends of the first transverse beam;
a second flange is formed at an end of the second transverse beam;
corresponding to each of the two chassis beams, the first flange and the second flange are connected to each other through a plurality of first fasteners penetrating the chassis beam;
at least one of the first transverse beam and the second transverse beam penetrates the chassis beam through a plurality of second fasteners; and
the first flange overlaps an end of the first longitudinal beam and is fixed on the chassis beam through a third fastener penetrating the first flange, and/or the second flange overlaps an end of the second longitudinal beam and is fixed on the chassis beam through a fourth fastener penetrating the second flange.

3. The mounting rack according to claim 1, wherein:
the first assembly member is disposed at the first transverse beam, and the second assembly member is disposed at the first longitudinal beam and the outer side beam; or
the first assembly member is disposed at the first longitudinal beam, and the second assembly member is disposed at the second transverse beam.

4. The mounting rack according to claim 1, wherein each of the first assembly member and the second assembly member is a floating nut.

5. The mounting rack according to claim 1, wherein the first assembly unit comprises three first transverse beams to define two first accommodation cavities, wherein:
two lateral first transverse beams of the three first transverse beams are each provided with a positioning portion configured to position the battery pack; and
two positioning portions are symmetrically arranged relative to a middle first transverse beam of the three first transverse beams.

6. The mounting rack according to claim 5, wherein:
the positioning portion comprises a square positioning column, a circular limit hole being formed at a center of the square positioning column; and
the positioning portion is integrally formed at the corresponding first transverse beam.

7. The mounting rack according to claim 4, wherein:
the two chassis beams are correspondingly provided with two second assembly units, respectively;
each of the two second assembly units comprises three second transverse beams to define two second accommodation cavities; and
the outer side beam is connected to ends of the three second transverse beams facing away from the corresponding chassis beam.

8. The mounting rack according to claim 7, wherein, for each of the two second assembly units:
at least two outer side beams are arranged at intervals in a vertical direction, two outer side beams of the at least two outer side beams being connected through a reinforcing plate; and
each of the at least two outer side beam is connected to the second transverse beam, a reinforcing angle plate being connected between the outer side beam and the second transverse beam.

9. The mounting rack according to claim 1, wherein the first transverse beam, the first longitudinal beam, the second transverse beam, and the second longitudinal beam are each a cast part.

10. A vehicle, comprising:
a vehicle body;
two chassis beams connected to a bottom of the vehicle body;
a mounting rack for a battery pack, the mounting rack being mounted at the two chassis beams, the mounting rack having a first direction consistent with an extending direction of the chassis beams and a second direction perpendicular to the first direction, the mounting rack comprising:
a first assembly unit adapted to be mounted between two chassis beams, wherein the first assembly unit comprises:
at least two first transverse beams arranged at intervals in the first direction, two ends of each of the at least two first transverse beams being adapted to be connected to the two chassis beams, respectively;
at least two first longitudinal beams, each of the at least two first longitudinal beams being arranged between every two adjacent first transverse beams of the at least two first transverse beams, the every two adjacent first transverse beams and the two chassis beams located between the every two adjacent first transverse beams defining a first accommodation cavity configured to mount a fixing block of the battery pack, and the at least two first longitudinal beams being arranged in the first accommodation cavity and connected to the two chassis beams, respectively; and
a first assembly member connected to the battery pack;
a second assembly unit adapted to be mounted at a side of each of the two chassis beams facing away from the first assembly unit, the second assembly unit comprising:
at least two second transverse beams arranged at intervals in the first direction, each of the at least two second transverse beams having an end adapted to be connected to the chassis beam;
an outer side beam connected to an end of each of the at least two second transverse beams facing away from the chassis beam, wherein every two adjacent second transverse beams of the at least two second transverse beams, the chassis beam located between the every two adjacent second transverse beams, and the outer side beam define a second accommodation cavity configured to mount a fixing block of the battery pack; and
a second longitudinal beam arranged between the every two adjacent second transverse beams, the second longitudinal beam being connected to the chassis beam and located in the second accommodation cavity; and
a second assembly member connected to the battery pack,
wherein each of the two chassis beams is provided with at least one of the first longitudinal beam and the second longitudinal beam.

11. The vehicle according to claim 10, wherein:
a first flange is formed at each of the two ends of the first transverse beam;
a second flange is formed at an end of the second transverse beam;
corresponding to each of the two chassis beams, the first flange and the second flange are connected to each other through a plurality of first fasteners penetrating the chassis beam;
at least one of the first transverse beam and the second transverse beam penetrates the chassis beam through a plurality of second fasteners; and
the first flange overlaps an end of the first longitudinal beam and is fixed on the chassis beam through a third fastener penetrating the first flange, and/or the second flange overlaps an end of the second longitudinal beam and is fixed on the chassis beam through a fourth fastener penetrating the second flange.

12. The vehicle according to claim 10, wherein:
the first assembly member is disposed at the first transverse beam, and the second assembly member is disposed at the first longitudinal beam and the outer side beam; or
the first assembly member is disposed at the first longitudinal beam, and the second assembly member is disposed at the second transverse beam.

13. The vehicle according to claim 10, wherein each of the first assembly member and the second assembly member is a floating nut.

14. The vehicle according to claim 10, wherein the first assembly unit comprises three first transverse beams to define two first accommodation cavities, wherein:
two lateral first transverse beams of the three first transverse beams are each provided with a positioning portion configured to position the battery pack; and
two positioning portions are symmetrically arranged relative to a middle first transverse beam of the three first transverse beams.

15. The vehicle according to claim 14, wherein:
the positioning portion comprises a square positioning column, a circular limit hole being formed at a center of the square positioning column; and
the positioning portion is integrally formed at the corresponding first transverse beam.

16. The vehicle according to claim 13, wherein:
the two chassis beams are correspondingly provided with two second assembly units, respectively;
each of the two second assembly units comprises three second transverse beams to define two second accommodation cavities; and
the outer side beam is connected to ends of the three second transverse beams facing away from the corresponding chassis beam.

17. The vehicle according to claim 16, wherein, for each of the two second assembly units:
at least two outer side beams are arranged at intervals in a vertical direction, two outer side beams of the at least two outer side beams being connected through a reinforcing plate; and
each of the at least two outer side beam is connected to the second transverse beam, a reinforcing angle plate being connected between the outer side beam and the second transverse beam.

18. The vehicle according to claim 10, wherein the first transverse beam, the first longitudinal beam, the second transverse beam, and the second longitudinal beam are each a cast part.
